(19) United States
(12) Patent Application Publication
(10) Pub. No.: US 2026/0231248 A1
(43) Pub. Date: Aug. 6, 2026

(54) Apparatus For Controlling A Radio Transmission/Radio Receiving Device

(71) Applicant: Siemens Aktiengesellschaft, München (DE)

(72) Inventors: Nicola Michailow, München (DE); Volkmar Döricht, München (DE)

(73) Assignee: Siemens Aktiengesellschaft, München (DE)

(21) Appl. No.: 19/146,717

(22) PCT Filed: Dec. 28, 2023
(86) PCT No.: PCT/EP2023/087889

§ 371 Date: Jul. 9, 2025

(30) Foreign Application Priority Data
Jan. 13, 2023 (DE) 10 2023 200 259.0

(51) Int. Cl. H04W 76/10; G08C 17/02

(52) U.S. Cl. CPC H04W 76/10; G08C 17/02

(57) ABSTRACT

Various embodiments of the teachings herein include an apparatus for controlling a first radio transmission/radio reception device for integration in a system, said radio transmission/radio reception device having a first interface for communication, localization based on radio transmission/radio reception of electromagnetic waves, and/or sensing, and is wireless according to a radio communication standard. An example includes: a second interface to transmit a control signal to the first radio transmission/radio reception device, wherein the first radio transmission/radio reception device, by receiving and/or interpreting the control signal, at least temporarily provides and/or disconnects the first interface so the interface is optionally operated temporarily for communication, localization and/or sensing so the machine process is carried out by accessing data exchanged by operation of the radio transmission/radio reception apparatus.

### CROSS-REFERENCE TO RELATED APPLICATIONS

This application is a U.S. National Stage Application of International Application No. PCT/EP2023/087889 filed Dec. 28, 2023, which designates the United States of America, and claims priority to DE Application No. 10 2023 200 259.0 filed Jan. 13, 2023, the contents of which are hereby incorporated by reference in their entirety.

### TECHNICAL FIELD

The present disclosure relates to radio transmissions. Various embodiments of the teachings herein include systems and/or methods for controlling radio transmission/radio reception devices that can be integrated in a system that can be formed for interaction with at least one machine process, for example in an industrial environment, radio transmission/radio reception devices, systems and control methods.

### BACKGROUND

The use of radio transmission/radio reception devices, in particular mobile radio transmission/radio reception devices, in mobile radio communication networks according to radio communication standards, such as the “Global System Mobile”, GSM, or 2G, 3G or “Long Term Evolution”, LTE, or 4G standard, is known. Said standards were typically distinguished, in particular, by the fact that the subsequent development allowed the radio transmission/radio reception devices more bandwidth for communication that was increasingly also used for mobile data transmission for using the so-called mobile Internet. At the same time, the power of the radio transmission/radio reception devices increased and various applications were developed that enabled use of the radio transmission/radio reception devices beyond pure communication and Internet use.

These functions substantially used in the private sphere also increasingly suggested use in the industrial/machine environment, which resulted in the current fifth generation mobile radio standard, 5G, providing not only an increase in bandwidth, inter alia, but also enabling an increase in the number of cells as well as smaller, in particular isolable, cells, and allowed, for example, isolated radio supply without access by third parties, which enabled, in particular, industrial use of the functions of radio transmission/radio reception devices.

Wireless communication systems of the sixth generation, 6G, of the mobile radio standard are expected to integrate a plurality of functionalities in the air interface which is used by the radio transmission/radio reception devices and is also referred to as a wireless interface. Functions of the radio transmission/radio reception devices may be addressed and used directly via the air interface without the need for complex applications. Projects such as Hexa-X suggest that 6G will have a close integration of localization and sensing with communication functions. The radio transmission/radio reception devices used in such an environment are accordingly referred to as “Integrated Communications and Sensing”, ICAS, devices.

These functions will not only enable new applications requiring an extreme localization performance but will also be a means for supporting and improving communication functions.

WYMEERSCH, Henk, et al. Integration of communication and sensing in 6G: A joint industrial and academic perspective provides an overview of the Hexa-X vision and the planned applications. It is also explained there how the performance gap required for these applications with respect to 5G can be closed. In this respect, a plurality of different technical requirements and the associated research challenges for the coming years are explained. A specific implementation of the integration of the functions of radio transmission/radio reception apparatuses, in particular for the machine processes in the industrial environment, is not mentioned or disclosed there.

### SUMMARY

The teachings of the present disclosure may be used to overcome disadvantages of the prior art and specify a technical solution for integrating functions of radio transmission/radio reception apparatuses, in particular for machine processes in the industrial environment. For example, some embodiments include an apparatus for controlling at least one first radio transmission/radio reception device that can be integrated in a system that can be formed, in particular for interaction with at least one machine process, for example in an industrial environment, said radio transmission/radio reception device being configured in such a manner that it is configured with at least one first interface that can be at least temporarily operated for communication, localization based on radio transmission/radio reception of electromagnetic waves and/or sensing and is configured to be wireless according to at least one radio communication standard, characterized in that the control apparatus has a second interface that can be used to transmit at least one control signal to the radio transmission/radio reception devices in such a manner that the first radio transmission/radio reception device can be configured, by receiving and/or interpreting the control signal, at least to at least temporarily provide and/or disconnect the first interface providing at least parts of the communication, localization and/or sensing in such a manner that the interface is optionally operated at least temporarily for communication, localization and/or sensing in such a manner that the machine process is carried out by accessing at least the data exchanged by the operation of the radio transmission/radio reception apparatus.

In some embodiments, the second interface is configured for wireless communication according to a radio communication standard, in particular corresponding to one of the radio communication standards of the first interface.

In some embodiments, the control apparatus has a third interface which is configured for wired communication and is configured in such a manner that the control apparatus is at least releasably fastened to an apparatus having at least the second interface, in particular a first radio transmission/radio reception device.

In some embodiments, the second interface is configured for wired communication in such a manner that it can be additionally operated as a third interface.

In some embodiments, a communication connection can be provided via the first, second and/or third interface in such a manner that it is at least temporarily configured to cooperatively perform at least parts of functions of a system, in particular a system that can be operated in the industrial environment.

In some embodiments, the control apparatus interacts with a fourth interface, in particular by using the first, second or third interface, for interaction with a so-called “Embodied Artificial Intelligence”, E-AI, system for influencing at least one physical variable, in particular in the industrial environment.

In some embodiments, the E-AI_system is formed at least by machines, for example robot arms, so-called “Computer Numerical Control”, CNC, machines, autonomous vehicles, in particular stationary and/or mobile robots, and/or comparable controllable apparatuses that can be used industrially.

In some embodiments, the control apparatus includes a first module for capturing one or more parameters and/or one or more statuses of the system, in particular a) a state of the E-AI system that can be determined, for example, by querying at least one parameter of a digital twin of the E-AI system that is integrated in the E-AI system and/or can be at least temporarily functionally connected, b) a task currently being performed by the E-AI system and/or a history associated with the task, in particular parameters and/or training data collected by the E-AI system during earlier performances of the task, c) a context of the E-AI system, for example the physical environment of at least one part of the E-AI system and/or adjacent E-AI systems, physically capturable first values, for example the location of adjacent E-AI systems, or values represented by a parameter of the respective digital twin, such as physical variables, or d) the current parameters and Capabilities of all ICAS devices in the E-AI system.

In some embodiments, the first module can be functionally connected to a fifth interface and operated in such a manner that one or more parameters and/or one or more statuses of the system are captured by the first module accessing, via the fifth interface, a) data stored in a structured manner in a database, in particular a database connected via the fifth interface, b) data which are stored in a structured manner, can be retrieved via the fifth interface by a second module implementing a machine learning model and represent current states of the system and/or parts thereof, or c) data stored in a structured manner and represented using a semantic graph and the data are evaluated.

In some embodiments, the control apparatus includes a third module which is used to capture, in particular read, the first value and/or second value via an interface.

As another example, some embodiments include a radio transmission/radio reception device configured for operation in an industrial environment and configured in such a manner that it is configured with at least one first interface that can be operated at least temporarily for communication, localization based on radio transmission/radio reception of electromagnetic waves and/or sensing and is configured to be wireless according to at least one radio communication standard, characterized in that it has an interface corresponding to the second interface of the control apparatus as claimed in one of the preceding claims, wherein the first radio transmission/radio reception device is configured, and the interface corresponding to the second interface can be functionally connected and operated, in such a manner that, by receiving and/or interpreting one of the control signals via the to the second interface, it can be configured to at least temporarily provide and/or disconnect the first interface providing at least parts of the communication, localization and/or at least parts of the sensing in such a manner that it is optionally operated at least temporarily for communication, localization and/or sensing.

As another example, some embodiments include a system for controlling at least one first radio transmission/radio reception device that can be integrated in a system that can be formed, in particular for interaction with at least one machine process, for example in an industrial environment, having at least one control apparatus as described herein and at least one radio transmission/radio reception device as described herein.

As another example, some embodiments include a method for controlling at least one first radio transmission/radio reception device that can be integrated in a system that can be formed, in particular for interaction with at least one machine process, for example in an industrial environment, characterized by at least one control apparatus and at least one radio transmission/radio reception device as described herein, which are functionally connected and operated in such a manner that the control apparatus controls at least parts of the functions of the radio transmission/radio reception device via the second interface, wherein the control is carried out in such a manner that the integration, in particular the machine process, is at least temporarily carried out at least using the communication, localization and/or sensing operation of the radio transmission/radio reception device.

In some embodiments, the control apparatus controls a multiplicity of first radio transmission/radio reception devices.

In some embodiments, at least two first radio transmission/radio reception devices are controlled by the control apparatus in such a manner that they at least temporarily maintain a communication connection, in particular as part of a network, for example formed in the manner of the mesh, in which case they form a radar in the manner of the so-called “Multiple Input Multiple Output”, MIMO, array in this time.

In some embodiments, at least one of the multiplicity of first radio transmission/radio reception devices is controlled by the control apparatus to receive signals in such a manner that localization, in particular of its own position, is carried out on the basis of the received signals.

In some embodiments, at least one of the multiplicity of first radio transmission/radio reception apparatuses is controlled by the control apparatus in such a manner that, as a sensor, it at least temporarily captures at least one value of at least one physical variable.

### BRIEF DESCRIPTION OF THE DRAWINGS

Exemplary embodiments incorporating teachings of the present disclosure are explained in more detail below with reference to FIGS. 1 to 4. In FIGS. 1 to 4, identical or functionally identical elements are provided with the same reference signs, unless stated otherwise. In the figures:

FIG. 1 schematically shows an example radio transmission/radio reception device incorporating teachings of the present disclosure;

FIG. 2 schematically shows an example control apparatus incorporating teachings of the present disclosure;

FIG. 3 schematically shows an example system incorporating teachings of the present disclosure;

FIG. 4 schematically shows an example method incorporating teachings of the present disclosure when used in the a system integrated in an E-AI system.

### DETAILED DESCRIPTION

An example apparatus incorporating teachings of the present disclosure for controlling at least one first radio transmission/radio reception device that can be integrated in a system that can be formed, in particular for interaction with at least one machine process, for example in an industrial environment, said radio transmission/radio reception device being configured with at least one first interface that can be at least temporarily operated for communication, localization based on radio transmission/radio reception of electromagnetic waves and/or sensing and is configured to be wireless according to at least one radio communication standard, the control apparatus has a second interface that can be used to transmit at least one control signal to the radio transmission/radio reception device in such a manner that the first radio transmission/radio reception device can be configured, by receiving and/or interpreting the control signal, at least to at least temporarily provide and/or disconnect the first interface providing at least parts of the communication, localization and/or sensing in such a manner that the interface is optionally operated at least temporarily for communication, localization and/or sensing in such a manner that the machine process is carried out by accessing at least the data exchanged by the operation of the radio transmission/radio reception apparatus.

Resources of one or more radio transmission/radio reception devices that can be integrated in a system are used optimally since individual functions or combinations of their functions are used or operated as required. The teachings also make it possible for the radio transmission/radio reception devices to be able to achieve this virtually without a large amount of implementation effort since there is a need only for the second interface and the control apparatus and for the method to be carried out in order to achieve this.

It is therefore also possible to use common radio transmission/radio reception devices provided that they are operated in accordance with the methods described herein, in particular one of their interfaces is operated as a second interface to the control apparatus. It is possible to use radio transmission/radio reception devices on a broad basis in the new ranges of tasks mentioned at the outset. The control apparatus nat control a plurality of radio transmission/radio reception devices, since it can distribute and manage individual functions for a system requiring a plurality of functions. This provides many degrees of freedom, for example in terms of the place of use of the respective radio transmission/radio reception device or its assignment to a network, work location or connection to artificial intelligence.

The radio transmission/radio reception device configured for operation in an industrial environment is configured in such a manner that it is configured with at least one first interface that can be operated at least temporarily for communication, localization based on radio transmission/radio reception of electromagnetic waves and/or sensing and is configured to be wireless according to at least one radio communication standard, and has an interface corresponding to the second interface of the control apparatus, wherein the first radio transmission/radio reception device is configured, and the interface corresponding to the second interface can be functionally connected and operated in such a manner that, by receiving and/or interpreting one of the control signals via the to the second interface, it can be configured to at least temporarily provide and/or disconnect the first interface providing at least parts of the communication, localization and/or at least parts of the sensing in such a manner that it is optionally operated at least temporarily for communication, localization and/or sensing.

These advantages are also achieved, mutatis mutandis, by the radio transmission/radio reception devices described herein since it is configured to interact with the control apparatus and therefore to carry out the methods, thus contributing to achieving the advantages mentioned.

The system according to the invention for controlling at least one first radio transmission/radio reception device that can be integrated in a system that can be formed, in particular for interaction with at least one machine process, for example in an industrial environment, is characterized by at least one control apparatus and at least one radio transmission/radio reception device as described herein as a first radio transmission/radio reception device.

The previously mentioned descriptions also apply, in particular, mutatis mutandis, to the systems since it is formed by the control apparatus and at least one radio transmission/radio reception device. This also provides a minimum arrangement which carries out one or more of the methods and not only affords the above-mentioned advantages with regard to optimum use of the resources, but also provides flexible configurable functions for technical tasks going beyond pure communication.

An example method for controlling at least one first radio transmission/radio reception device that can be integrated in a system that can be formed, in particular for interaction with at least one machine process, for example in an industrial environment, is characterized by at least one control apparatus and at least one radio transmission/radio reception device, which are functionally connected and operated in such a manner that the control apparatus controls at least parts of the functions of the radio transmission/radio reception device via the second interface, wherein the control is carried out in such a manner that the integration, in particular the machine process, is at least temporarily carried out at least using the communication, localization and/or sensing operation of the radio transmission/radio reception device. The method achieves the features in the above-mentioned substantive embodiments, mutatis mutandis, since the performance of the method makes it possible to implement them. Further advantageous configurations and developments of the teachings herein are indicated by the subclaims.

Unless stated otherwise in the following description, the terms “carry out”, “calculate”, “computer-aided”, “compute”, “determine”, “generate”, “configure”, “reconstruct” and the like preferably relate to actions and/or processes and/or processing steps which change and/or generate data and/or convert the data into other data, wherein the data may be represented or be present, in particular, as physical variables, for example as electrical pulses. In particular, the expression “radio transmission/radio reception device” should be interpreted as broadly as possible in order to cover, in particular, all electronic devices with data processing properties and according to higher mobile radio communication standards, for example the sixth generation and higher or derivatives. Radio transmission/radio reception devices can therefore be, for example, personal computers, servers, programmable logic controllers (PLC), handheld computer systems, pocket PC devices, mobile radio devices and other machine parts which can process data in a computer-aided manner and can transmit data according to the mobile radio standard, processors and other electronic devices for wireless data transmission.

In connection with the disclosure, “computer-aided” can be understood as meaning, for example, an implementation of the method, in which a processor, in particular, carries out at least one method step of the method.

In connection with the disclosure, a processor can be understood as meaning, for example, a machine or an electronic circuit. A processor may be, in particular, a main processor (Central Processing Unit, CPU), a microprocessor or a microcontroller. A processor may also be, for example, an IC (Integrated Circuit), in particular an FPGA (Field Programmable Gate Array) or an ASIC (Application-Specific Integrated circuit) or a DSP (Digital Signal Processor) or a graphics processor GPU (Graphic Processing Unit). A processor can also be understood as meaning a virtualized processor, a virtual machine or a soft CPU. It may also be, for example, a programmable processor that is equipped with configuration steps for carrying out said method according to the invention or is configured using configuration steps in such a manner that the programmable processor implements the features of the method, of the component, of the modules or of other aspects and/or partial aspects of the teachings herein.

In connection with the disclosure, a “memory unit” or a “memory module” and the like can be understood as meaning, for example, a volatile memory in the form of random access memory (RAM) or a permanent memory such as a hard disk or a data carrier and a combination of one or more of these elements for forming a so-called cloud.

In connection with the disclosure, a “module” can be understood as meaning, for example, at least one processor and/or at least one memory unit for storing program instructions which are physically functionally cooperatively connected at a location, for example a part of a printed circuit board, or also distributed among a plurality of entities of a network. For example, the processor is specifically configured to execute the program instructions in such a manner that the processor performs functions in order to implement or achieve the methods described herein.

A digital twin is configured, in particular, to represent or model a technical, chemical and/or physical behavior of at least parts of the system or products of the system and to therefore make it available as a parameter.

A “parameter” can be understood as meaning, in particular, a unit such as a physical property, a name, a size, a color, a type, a state, a parameter of a place of use etc., or a feature, a characteristic and/or a configuration of involved entities, such as the E-AI system, or a product.

An “E-AI system” can be understood as meaning, in particular, a machine such as a machine tool or a robot, a device such as a field device, an industrial installation such as a production installation, with embedded artificial intelligence.

The advantages mentioned below need not necessarily be achieved by the subjects of the independent patent claims. Rather, these may also be advantages which are achieved only by way of individual embodiments, variants, or developments. The same applies to the following explanations.

In some embodiments, the control apparatus has a third interface which is configured for wired communication and is configured in such a manner that the control apparatus is at least releasably fastened to an apparatus having at least the second interface, in particular a first radio transmission/radio reception device. As a result of such an interface, the control apparatus is therefore integrated temporarily, for example in a pluggable manner, as part of an apparatus tackling another task, in particular a system task, such as the radio transmission/radio reception device itself, or as part of an apparatus, in particular communication, infrastructure apparatus, or permanently, for example as part of the circuit and/or in the same housing. In particular, this can be implemented in such a manner that a processor of the apparatus, in particular of the radio transmission/radio reception device, implements the control both of the control apparatus according to the invention and the operational control of the apparatus, for example the radio transmission/radio reception device. For example, radio transmission/radio reception devices could therefore be structurally identical and the method according to the invention could be developed in such a manner that it assigns different tasks to the processors involved.

A radio transmission/radio reception device could also be used to implement the control apparatus, with the result that there is no need for an apparatus to be produced separately. In addition, there would be flexibility to the effect that, according to one development of the method according to the invention, a plurality of radio transmission/radio reception devices could accordingly organize themselves as a system. For this purpose, the second interface is configured for wired communication in such a manner that it can be additionally operated as a third interface. This reduces the second and third interfaces to one interface that integrates the control apparatus. This will be advantageous if only a single radio transmission/radio reception apparatus is integrated in the control apparatus and controls only it and/or this wireless interface enables the connection to a plurality of radio transmission/radio reception devices, as is the case, for example, in a bus system, in particular an industrial bus system.

In some embodiments, a communication connection can be provided via the first, second and/or third interface in such a manner that it is at least temporarily configured to cooperatively perform at least parts of functions of a system, in particular a system that can be operated in the industrial environment.

In some embodiments, the control apparatus has a fourth interface formed in particular by using the first, second or third interface and configured for interaction with a so-called “Embodied Artificial Intelligence”, E-AI, system for influencing at least one physical variable, in particular in the industrial environment. This provides the system with various possibilities, in particular provided by data from artificial intelligence, for control by means of artificial intelligence, in particular also in connection with digital twins of the system, which possibilities can immediately cause or anticipate changes in: the real environment. In some embodiments, the data accrued when performing sequences coordinated according to the invention can be provided for machine learning, with the result that they can optimize the respective E-AI system for future intervention in the real world, that is to say the world subjected to physical laws.

In some embodiments, the E-AI system is formed at least by machines, for example robot arms, so-called “Computer Numerical Control”, CNC, machines, autonomous vehicles, in particular stationary and/or mobile robots, and/or comparable controllable apparatuses that can be used industrially, this contributes to various applications in industry by making the radio transmission/radio reception devices with functionalities available according to a mobile radio standard of the sixth generation and/or a higher generation or their derivatives available to machines or being able to act as part of the machines.

In some embodiments, the control apparatus has a first module for capturing one or more parameters and/or one or more statuses of the system, in particular
a) a state of the E-AI system that can be determined, for example, by querying at least one parameter of a digital twin of the E-AI system that is integrated in the E-AI system and/or can be at least temporarily functionally connected,
b) a task currently being performed by the E-AI system and/or a history associated with the task, in particular parameters and/or training data collected by the E-AI system during earlier performances of the task,
c) a context of the E-AI system, for example the physical environment of at least one part of the E-AI system and/or adjacent E-AI systems, physically capturable first values, for example the location of adjacent E-AI systems, or values represented by a parameter of the respective digital twin, such as physical variables,
d) the current parameters and capabilities of all ICAS devices.

As a result, the control apparatus is able to dynamically adapt the required and/or operated functions to changes that occur in the system, in particular to anticipate these changes and/or their effects by using artificial intelligence, for example based on machine learning.

In some embodiments, the first module can be functionally connected to a fifth interface and operated in such a manner that one or more parameters and/or one or more statuses of the system are captured by the first module accessing, via the fifth interface, data stored in a structured manner in a database, in particular a database connected via the fifth interface, data which are stored in a structured manner, can be retrieved via the fifth interface by a second module implementing a machine learning model and represent current states of the system and/or parts thereof, and/or data stored in a structured manner and represented using a semantic graph, and the data are evaluated.

In some embodiments, the control apparatus has a third module which is used to capture, in particular read, the first value and/or second value via an interface. This information can be presented, for example, via an interface for reading parameters from a set of parameters stored in a database or as a parameter of a machine learning model or can be described using a semantic graph.

In some embodiments, the control apparatus controls a multiplicity of first radio transmission/radio reception devices. This makes it possible, for example, to distribute different tasks in a system, for example in a manner selected by parameters, wherein parameters take into account, for example, a prioritization of radio transmission/radio reception devices, in particular with regard to certain ones of their functions or the, in particular optimized, utilization of their resources and/or other variables representing changing or constant conditions, such as a degree of local proximity or a relative orientation/position with respect to the place of use and/or a determined object. This development therefore results in a wide variety of orchestration possibilities.

In some embodiments, at least two first radio transmission/radio reception devices are controlled by the control apparatus in such a manner that they at least temporarily maintain a communication connection, in particular as part of a network, for example formed in the manner of the mesh, in which case they form a radar in the manner of the so-called “Multiple Input Multiple Output”, MIMO, array in this time. Such a network is not only a further option for orchestration, in particular in a system, but also provides an additional or improved function which can also act or be offered in a manner distributed over a plurality of E-AI systems.

In some embodiments, at least one of the multiplicity of first radio transmission/radio reception devices is controlled by the control apparatus to receive signals in such a manner that localization, in particular of its own position, is carried out on the basis of the received signals. This development is one of the possibilities for carrying out localization by means of radio transmission/radio reception devices.

In some embodiments, at least one of the multiplicity of first radio transmission/radio reception devices is controlled by the control apparatus in such a manner that, as a sensor, it at least temporarily captures at least one value of at least one physical variable. This provides one of the various possibilities of the invention for carrying out a sensing task. In particular, a function is thus available in the system and, like the developments mentioned above, can be used, in particular, in machine processes and can be orchestrated by the methods described herein.

The following exemplary embodiments show only exemplary implementation possibilities as to what such implementations of the teachings herein could look like, in particular, since it is impossible and also not expedient or necessary for the understanding to mention all of these implementation possibilities.

The described components of the embodiments each constitute individual features of the teachings herein that should be considered independently of one another and that each also develop independently of one another, and may thus also be considered part of the disclosure in their own right or in any combination other than that disclosed. The described embodiments may also be supplemented by further features that have already been described.

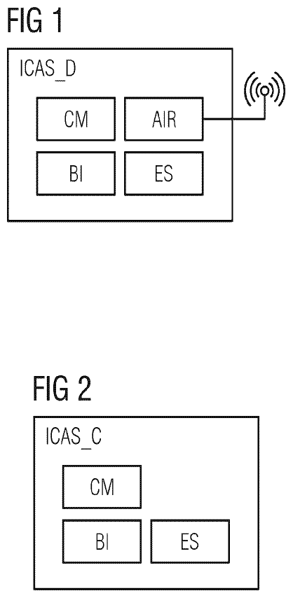

The same reference signs have the same meaning in the various figures. They thus denote the same units and/or units that provide the same function. FIG. 1 schematically shows the structure of a radio transmission/radio reception device ICAS_D incorporating teachings of the present disclosure, which is also referred to as a so-called ICAS device. A rough division into functional blocks of the radio transmission/radio reception device ICAS_D can be seen.

On the one hand, the radio transmission/radio reception device ICAS_D has a functional block which is required for the computer and memory apparatus needed to operate and control the functions of the radio transmission/radio reception device ICAS_D and which can also be referred to as a “compute & memory” block. This may be one or more predominantly integrated switching elements, in particular one or more processor and memory chips.

Furthermore, a functional block for the energy supply ES (“Energy Source”) is provided for operating the radio transmission/radio reception device ICAS_D. This may be in the form of a battery or rechargeable battery, a grid supply and/or a comparable supply, for example the so-called “Power over Ethernet” supply. Furthermore, it is possible to see a functional block which implements the functional block of the air interface AIR that is also essential for a radio transmission/radio reception device.

The air interface AIR will typically have analog and/or digital radio transmission components, also referred to as so-called “Radio Frequency Components”, and the emission devices needed for such a transmission, that is to say essentially one or more antennas. This air interface AIR configured in this manner can be developed in such a manner that it complies with one or more standards for wireless or radio communication, that is to say enables communication in various ways; this can also take place using one or more frequency bands. The common feature of this first interface AIR of the device is that signals, in particular data, are transmitted bidirectionally or unidirectionally according to one or more standards by transmitting and/or receiving electromagnetic waves. In addition to the radio wave applications, these may also be understood as meaning, according to the invention, radar applications and/or spectrography applications or the like.

The illustrated radio transmission/radio reception device ICAS_D is therefore able, with this first interface AIR, to transmit and receive waveforms for various purposes, specifically for
communication
localization
detection, for example using radar or spectrography.

In addition to communication, sensor capabilities can therefore also be implemented. Therefore, the radio transmission/radio reception device ICAS_D according to the exemplary embodiment of the invention is also referred to as a so-called “Integrated Communication And Sensing Device”, ICAS device.

The radio transmission/radio reception device ICAS_D therefore has functions that go beyond communication and are expected to be provided in 6G communication systems and further comparable communication systems going beyond 5G and/or subsequent communication standards, and applications supporting in particular machine processes, in particular processes carried out in the industrial environment, can be used. For this purpose, the exemplary embodiment of the radio transmission/radio reception device ICAS_D has a further functional block which implements a backhaul interface BI as the second interface.

This second interface BI can be connected, via a wireless air interface or a wired interface, to a control apparatus according to the invention, for example the embodiment of the control apparatus ICAS_C shown in FIG. 2, for communication, with the result that the radio transmission/radio reception device ICAS_D can use this second interface BI to receive data which result in individual, a plurality of or all functions of the radio transmission/radio reception device ICAS_D being controlled and/or to send data which are provided by individual, a plurality of or all functions and to forward and/or use said data, via this second communication connection available as a backhaul interface BI, for the above-mentioned applications, in particular machine processes carried out in the industrial environment.

This backhaul interface BI therefore makes it possible, as an example method, to externally control the functions of the radio transmission/radio reception device ICAS_D, with the result that the radio transmission/radio reception device ICAS_D can be largely flexibly used for such processes without adaptations, and functions, individually or together, result in state changes, for example activated and/or deactivated and/or reacting to states of the process and/or commands, and parameters of individual, a plurality of or all functions are adapted.

In some embodiments, the backhaul interface BI, if it is at least partially wireless, may be implemented by means of parts of the first interface AIR, that is to say the feedback in accordance with the control method takes place at least partially via the first interface AIR. In some embodiments, the first interface AIR, as an alternative or in addition to the second interface BI, provides the feedback, for example in order to equip the device ICAS_D with the flexibility to be able to be connected to the control apparatus ICAS_C both wirelessly via the first interface AIR and in a wired manner via the second interface.

In some embodiments, it is possible for a series of such ICAS devices to be able to be integrated in a larger system, for example a driverless transport system or a factory robot. A management unit for such clusters of ICAS devices, by means of the backhaul interface BI and the control unit described herein, which, in accordance with the methods, the cluster formed by devices such as the radio transmission/radio reception device ICAS_D.

This provides the advantage, inter alia, that this apparatus:
monitors the operation of the ICAS cluster
can dynamically assign tasks to the ICAS devices, that is to say, for example, the duration and type of function(s) intended to be provided by the device.

Further details of the control apparatus become clear from the exemplary embodiment of the control apparatus ICAS_C (“Controller”) which is schematically illustrated in FIG. 2. This is an apparatus which, according to an exemplary embodiment of the method, can manage parameters and, by means of the latter, can manage the configuration of a series of ICAS devices which are configured, for example, like the ICAS device ICAS_D described in FIG. 1.

A rough division into functional blocks, as a schematic illustration of an exemplary embodiment of the control apparatus ICAS_C, can likewise be seen in FIG. 2. On the one hand, the exemplary embodiment of the control apparatus ICAS_C likewise has a functional block, the computer and memory apparatus CM needed to operate and control the functions of the exemplary embodiment of the control apparatus ICAS_C. This may likewise be one or more predominantly integrated switching elements, in particular one or more processor and memory chips.

Furthermore, a functional block for the energy supply ES is also provided for operating the exemplary embodiment of the control apparatus ICAS_C according to the invention. This may also be in the form of a battery or rechargeable battery, a grid supply and/or a comparable supply, for example the so-called “Power over Ethernet” supply.

In contrast to the exemplary embodiment of the radio transmission/radio reception device ICAS_D, the exemplary embodiment of the control apparatus ICAS_C does not have an air interface AIR, but only the interface BI which corresponds to the backhaul interface BI of the exemplary embodiment of the radio transmission/radio reception device ICAS_D and is therefore designated in an identical manner and, according to the exemplary embodiment, is in the form of a wired interface, for example an interface that enables communication via a bus system, in particular a bus system configured and operated according to an industrial standard.

However, the control apparatus is not restricted thereto. The control apparatus ICAS_C may also be configured in such a manner that it has a first air interface AIR and/or a wired second interface BI as an alternative or in addition to the wired interface BI, and the feedback is at least partially implemented using said interface(s).

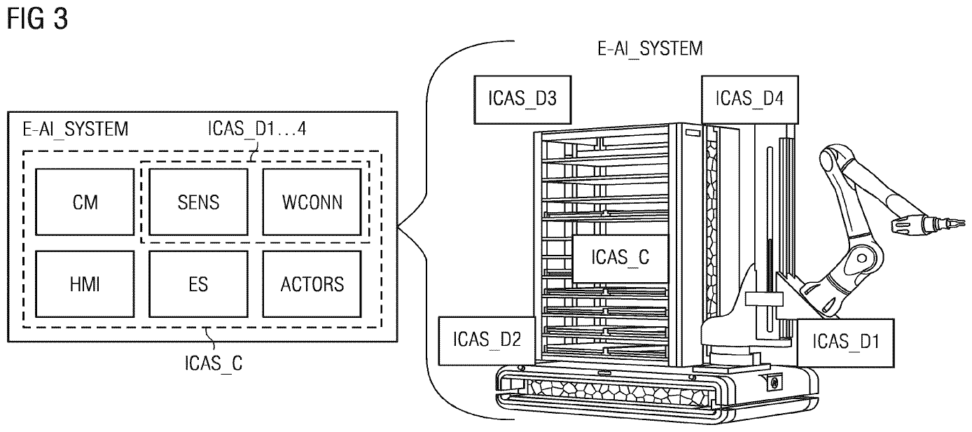

FIG. 3 schematically shows an exemplary embodiment of an example system as part of an E-AI system which is integrated in an embodied AI system E-AI_SYSTEM, for example on the basis of the control apparatus ICAS_C and a plurality of ICAS devices ICAS_D1 . . . 4 which, according to the exemplary embodiment of the radio transmission/radio reception device ICAS_D are formed as an exemplary embodiment of the system. On the one hand, a schematic illustration of the functional units of such an embodied AI system E-AI_SYSTEM and, on the other hand, an illustration of the E-AI system E-AI_SYSTEM integrating the system according to the invention can be seen as a possible industrial application in an intelligent robot assistant which is mobile and is provided with a plurality of sensors.

It is schematically illustrated that the sensors of the robot are formed by radio transmission/radio reception devices ICAS_D1 . . . 4 which are configured and are connected to a control apparatus ICAS_C for the purpose of carrying out the methods.

The connection is not illustrated. It may be partially enabled by a wired bus system integrated in the robot and/or may be completely or partially formed by the first air interface AIR present in the radio transmission/radio reception devices ICAS_D1 . . . 4 or the second interface BI, provided that they are at least partially configured for wireless communication. In some embodiments, the control apparatus ICAS_C may configure, via the wired backhaul interface BI, that is to say here the bus system, one or more of the ICAS devices ICAS_D1 . . . 4 in such a manner that the control apparatus ICAS_C configures and at least temporarily uses one or more of the air interfaces AIR of the radio transmission/radio reception devices ICAS_D1 . . . 4 as a backhaul connection to ICAS devices ICAS_D1 . . . 4 communicating in a purely wireless manner.

The schematic illustration of the exemplary embodiment of the system that is integrated in this illustration of an industrial application shows, in a simplified manner, the basic elements of an E-AI system E-AI_SYSTEM. It can be seen that such a system E-AI_SYSTEM likewise again has a functional block having a computer and memory apparatus CM needed to operate and control the functions of the E-AI system E-AI_SYSTEM. This may again be one or more predominantly integrated switching elements, in particular one or more processor and memory chips. They may be mounted on-board, or completely or partially at an unconnected location, and can be connected to the remaining functional units in a wired or wireless manner. For example, parts of the control can be outsourced as a whole or in a manner distributed among a plurality of entities, for example distributed computer apparatuses, and/or parts of the memory may be implemented at an unconnected location or at a remote location as a whole or in a manner distributed among a plurality of entities, for example a cloud.

Furthermore, a functional block for the energy supply ES is also provided for operation. This may again be in the form of a battery or rechargeable battery, a grid supply and/or comparable supply, for example the so-called “Power over Ethernet” supply.

Such an E-AI system E-AI_SYSTEM will additionally have one or more human-machine interfaces HMI which enable interaction between the human and the machine, for example a keyboard, a display, an audio output, a video output, virtual or augmented reality, headsets or the like.

There is also a functional block which consists of one or more actuators ACTORS which are responsible for manipulating physical parameters, that is to say the effect of the E-AI system E-AI_SYSTEM on the real world, that is to say bring about actions with and/or without physical effects. With regard to the illustrated robot, these could therefore be, for example, (micro) motors for moving gripping arms and fingers or motors for moving the entire robot to different locations. However, any conceivable function within a machine-assisted process is possible both for the robot and generally in machines.

Two functional blocks expected in an E-AI system in conjunction with radio transmission/radio reception devices ICAS_D1 . . . 4, which are configured according to standards of the sixth generation and higher or their derivatives, can also be seen: sensors SENS and wireless connectivities WCONN based on electromagnetic waves, that is to say radio waves in particular.

In connection with radio transmission/radio reception devices ICAS_D1 . . . 4, this means that the ICAS devices ICAS_D1 . . . 4 can completely or partially form the sensor functionality and/or wireless connection of an E-AI system E-AI_SYSTEM. This is intended to be illustrated in FIG. 3 by enclosing the functional blocks SENS, WCOMM to form a first functional group formed by all ICAS devices ICAS_D1 . . . 4 and referred to as such.

So that these ICAS devices ICAS_D1 . . . 4 according to the invention implement the methods described herein, these ICAS devices ICAS_D1 . . . 4 all have a haulback connection BI to the control apparatus ICAS_C. Since the control apparatus ICAS_C operates according to specifications from the E-AI system E-AI_SYSTEM, it will receive these specifications continuously also from the system E-AI_SYSTEM in any form accessible to a person skilled in the art, for example via a communication connection, and/or at at least one discrete time, for example by receiving stored computer program products and/or data. In principle, individual or all functional blocks of the E-AI system E-AI_SYSTEM, including the ICAS devices ICAS_C according to the invention, can therefore contribute to this. All functional blocks are therefore combined to form a second functional group ICAS_C.

The teachings of the disclosure are not restricted to integration in an E-AI system E-AI_SYSTEM; rather, communication and coordination for the configuration of ICAS devices ICAS_D according to the invention can be achieved by means of the invention over a plurality of E-AI systems. For this purpose, provision may be made to use more than one control apparatus ICAS_C; individual through to all ICAS devices ICAS_D1 . . . 4 may also be used beyond E-AI system E-AI_SYSTEM limits, for example interconnected to form functional clusters if necessary, that is to say can be controlled/configured together by means of one or more control apparatuses ICAS_C.

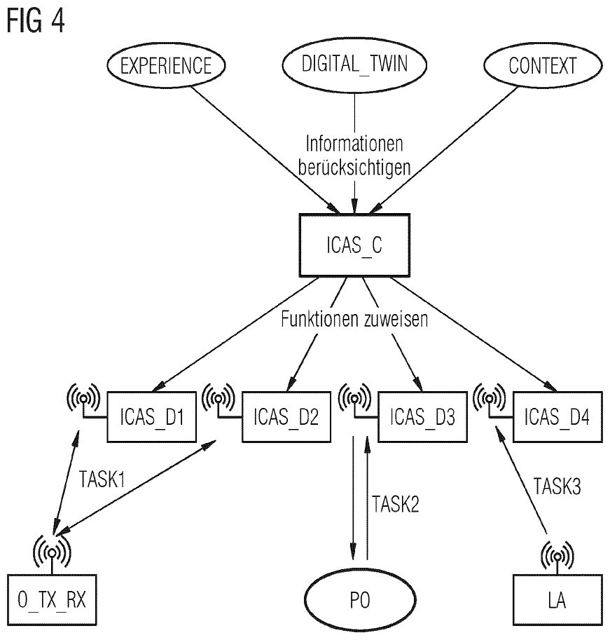

FIG. 4 schematically illustrates an example method used in the exemplary embodiment of the system which is integrated in an E-AI system, on the basis of which further details of the method and its configurations and/or developments as well as further arrangement features of entities according to the invention are shown. For this purpose, the integration of the method in a robot, as illustrated in FIG. 3, is taken as a basis. This is illustrated by virtue of the four ICAS devices ICAS_D1 . . . 4 indicated in FIG. 3 and the control apparatus ICAS_D according to the invention being illustrated individually, together with their indicated function(s) TASK1 . . . 3 and/or interfaces, in this system E-AI_SYSTEM.

A first radio transmission/radio reception device ICAS_D1 and a second radio transmission/radio reception device ICAS_D2 are configured by means of the method in such a manner that they together provide a first function TASK1 which involves maintaining a distributed “Multiple-Input Multiple-Output”, MIMO, connection. They therefore form a MIMO array which can receive radio waves from a further arbitrary radio transmission/radio reception device, for example a transmitter and/or receiver O_TX_RX, in the manner of the MIMO, and provide more specific functions or particular properties in connection with electromagnetic waves, as are used, for example, in (MIMO) radar and/or as part of radio communication. The robot according to the example is therefore configured with improved functions, in particular communication functions, available through MIMO.

A third radio transmission/radio reception device ICAS_D3 is configured, as a second task TASK2 in accordance with the method, in such a manner that it enables simple radar detection. The third ICAS device ICAS_D3 is therefore configured as a radar sensor by means of the method and makes this function available to the robot. This can be used, for example, to identify objects to be gripped and/or obstacles (“Physical Obstacle”) PO; the latter in order to avoid collisions when moving the robot, for example.

As a third task TASK3, the fourth radio transmission/radio reception device ICAS_D4 provides a localization function and the fourth radio transmission/radio reception device ICAS_D4 is accordingly configured in accordance with the method, like all ICAS devices ICAS_D1 . . . 4, by means of the control apparatus ICAS_C. That is to say, the localization function that has been integrated by the fourth radio transmission/radio reception device ICAS_D4 is configured for self-localization. Applied to the application in the robot, this means that the position of the robot in space and/or the position of parts of the robot, for example the arm, is/are available to the robot as current position information in order to be able to control processes accordingly.

The localization can be implemented according to the so-called “Angle of Arrival”, the so-called “Time of Arrival” or a comparable approach, in which, as shown in the example, the self-localization can be carried out with the aid of a radio transmission/radio reception device configured as a localization anchor LA.

In some embodiments, the control apparatus ICAS_C configures the ICAS devices ICAS_D1 . . . 4 involved and assigns functions to them and also, for this purpose, sometimes combines the individual ICAS devices ICAS_D1 . . . 4 to form functional groups. This all takes place according to the exemplary embodiment of the method in such a manner that this can be carried out flexibly for finite periods and one, more or all of the functions of an ICAS device ICAS_D1 . . . 4 can be activated or deactivated if necessary. This takes place via the backhaul connection BI from the ICAS devices ICAS_D1 . . . 4 to the control apparatus ICAS_C and the hardware and software of the control apparatus ICAS_C.

In order to activate or deactivate, or also to control active functions for a specific process, in particular an industrial process, currently being operated, the control apparatus ICAS_C may also have, according to the exemplary embodiment, one or more connections to information sources that can contribute to generating corresponding control signals that bring about state changes and/or can provide these signals directly.

In some embodiments, the control apparatus ICAS_C takes into account one or more of the following knowledge bases for this purpose, specifically
a database EXPIRIENCE that contains information relating to past process executions and/or past times of the current task performance, that is to say takes into account the history, such that current control of future actions can be carried out on the basis of experience,
alternatively or additionally, in particular for parameterization, a digital twin DIGITAL_TWIN of the respective involved E-AI system E-AI_SYSTEM in order to use data relating to states and current tasks of the E-AI system E-AI_SYSTEM as a basis for future actions,
and/or contextual data CONTEXT from observations of the current and/or physical environment, for example location and/or state of other, in particular adjacent, E-AI systems.

The exemplary embodiments contribute individually and/or in combination, inter alia, to the following advantages which are summarized together with further details of the configurations or exemplary embodiments and advantageous developments of the invention that are sometimes described in other words:

The present disclosure enables flexible access to functions of radio transmission/radio reception devices of the newer radio standards, in particular of the sixth generation and later or derivatives thereof, which differ from today's radio transmission/radio reception devices, for example smartphones or industrial routers, for example SCALANCE M, to the effect that they provide more than only communication by way of their wireless interfaces. This makes it possible to flexibly equip devices, for example driverless transport systems or industrial robots, with sensor capabilities, for example, without equipping them with separate hardware, by applying the method according to the invention and introducing, inter alia, the control apparatus ICAS_C which, as a management unit, monitors and controls the (re) configuration of device functions of the ICAS devices ICAS_D1 . . . 4.

In some embodiments, the ICAS controller (control apparatus) ICAS_C can be connected to a series of ICAS devices ICAS_D1 . . . 4 via backhaul connections, that is to say the backhaul connection BI; in particular, the ICAS controller ICAS_C and ICAS devices ICAS_C may be part of an E-AI system E-AI_SYSTEM, for example an autonomous industrial robot.

The ICAS controller ICAS_C may take into account one or more of the following conditions:
A current status of the embodied AI system E-AI_SYSTEM that is stored, for example, on-board in its own digital twin DIGITAL_TWIN.
The task currently being performed by the E-AI system E-AI_SYSTEM and associated experience data EXPIRIENCE that were collected by the E-AI system E-AI_SYSTEM during earlier performances of the current task.
The context CONTEXT of the embodied AI system, for example a digital twin of the physical environment of the E-AI device E-AI_SYSTEM, including the locations and states of other E-AI systems.
The current parameters and capabilities of all ICAS devices ICAS_D1 . . . 4, in particular by way of clusters formed using all ICAS devices available in the surrounding E-AI systems.

This information can be stored and accessed, for example presented in the form of a database or as a parameter of a machine learning model or described with a semantic graph.

The ICAS controller ICAS_C may generate logical, associated task groups TASK1 . . . 3 in the form of assignments to each ICAS device ICAS_D1 . . . 4, for example according to the exemplary embodiment shown in FIG. 4:
First task group TASK1: ICAS devices 1 & 2 ICAS_D1 . . . 2 are configured in such a manner that they temporarily form a distributed MIMO array and maintain a wireless communication connection, for example as part of a mesh network formed by a swarm of E-AI systems.
Second task group TASK2: ICAS device 3 ICAS_D3 is configured for a sensor task.
Third task group TASK3: ICAS device 4 ICAS_D4 is used to receive signals needed for self-localization.

One of the major advantages of the dynamic assignment of ICAS tasks TASK1 . . . 3 to ICAS devices ICAS_D1 . . . 4, is, inter alia, that communication, energy and computing resources associated with a particular function (connectivity, localization, sensing) are assigned/used only when the functionality is also actually required. That is to say, for example, only when an application of the E-AI system E-AI_SYSTEM needs to know the location of the E-AI system E-AI_SYSTEM, the E-AI system E-AI_SYSTEM requests the control apparatus, ICAS controller, ICAS_C to configure an ICAS device ICAS_D1 . . . 4 for localization or the ICAS controller independently concludes this configuration by means of the information available via the E-AI system E-AI_SYSTEM.

This differs from the use of a fixed infrastructure, for example base stations in the 5G/6G campus network, in which time and frequency resources are constantly reserved in order to find the location of an E-AI system. Functions of devices ICAS_D1 . . . 4 having the backhaul connection BI can be managed through the backhaul connection BI by means of the control apparatus ICAS_C.

The ICAS devices ICAS_D1 . . . 4 can therefore dynamically adapt their functions when the environment of the system changes or they are configured to adapt. For example, if the E-AI system E-AI_SYSTEM is moved to a different location, and the robot moves, for example, to a different location to carry out a task orchestrated with other robots, this can be detected and states of the E-AI system E-AI_SYSTEM, that is to say the task groups TASK1 . . . 3 or their performance, can change accordingly. This is not limited to the described configurations and developments. On the contrary, all developments that fall within the scope of protection of the claims and combinations of individual, a plurality of or all of the claimed features according to the claims are included.

Where use has been made above of expressions that show or imply a grammatical gender and/or other features suitable for differentiating between humans, these expressions have not been used discriminately, but rather inclusively, that is to say all human beings-regardless of given, self-adopted or assumed individual features-are considered to be equal.

What is claimed is:

1. An apparatus for controlling first radio transmission/radio reception device integration in a system, said radio transmission/radio reception device having a first interface for communication, localization based on radio transmission/radio reception of electromagnetic waves, and/or sensing, and is wireless according to a radio communication standard, the apparatus comprising:
a second interface to transmit a control signal to the first radio transmission/radio reception device, wherein the first radio transmission/radio reception device, by receiving and/or interpreting the control signal, at least temporarily provide and/or disconnect the first interface so the interface is optionally operated temporarily for communication, localization and/or sensing so the machine process is carried out by accessing data exchanged by operation of the radio transmission/radio reception apparatus.

2. The control apparatus as claimed in claim 1, wherein the second interface is configured for wireless communication according to the radio communication standard.

3. The control apparatus as claimed in claim 1, further comprising a third interface for wired communication configured so the control apparatus is releasably fastened to the second interface.

4. The control apparatus as claimed in claim 3, wherein the second interface is configured for wired communication so it can be operated as the third interface.

5. The control apparatus as claimed in claim 3, wherein a communication connection can be provided via the first, second, and/or third interface so it is configured to cooperatively perform parts of functions of a system in an industrial environment.

6. The control apparatus as claimed in claim 3, configured to interact with a fourth interface using the first, second, or third interface, for interaction with “Embodied Artificial Intelligence”, E-AI, system for influencing a physical variable in an industrial environment.

7. The control apparatus as claimed in claim 6, wherein the E-AI system comprises robot arms, “Computer Numerical Control”, (CNC) machines, and/or autonomous vehicles.

8. The control apparatus as claimed in claim 1, further comprising a first module for capturing parameters and/or status of the system, including one or more of:
a) a state of the E-AI system that can be determined by querying a parameter of a digital twin of the E-AI system integrated in the E-AI system;
b) a task currently being performed by the E-AI system and/or a history associated with the task;
c) a context of the E-AI system, physically capturable first values, or values represented by a parameter of the respective digital twin; or
d) current parameters and capabilities of all ICAS devices in the E-AI system.

9. The control apparatus as claimed in claim 8, wherein the first module can be functionally connected to a fifth interface and operated so one or more parameters and/or one or more statuses of the system are captured by the first module accessing, via the fifth interface,
a) data stored in a structured manner in a database;
b) data which are stored in a structured manner, can be retrieved via the fifth interface by a second module implementing a machine learning model and represent current states of the system and/or parts thereof; and/or
c) data stored in a structured manner and represented using a semantic graph and the data are evaluated.

10. The control apparatus as claimed in claim 9, further comprising a third module to capture the first value and/or second value via an interface.

11. A radio transmission/radio reception device for operation in an industrial environment, the device comprising:
a first interface to at least temporarily communicate, localize based on radio transmission/radio reception of electromagnetic waves, and/or sense and wireless according to a radio communication standard; and
a second interface;
wherein the first radio transmission/radio reception device is configured, and the interface corresponding to the second interface can be functionally connected and operated, so, by receiving and/or interpreting one of the control signals via the second interface, it can be configured to at least temporarily provide and/or disconnect the first interface providing at least parts of the communication, localization, and/or at least parts of the sensing so it is optionally operated for communication, localization, and/or sensing.

12. (canceled)

13. A method for controlling a first radio transmission/radio reception device in a system in an industrial environment, the system having a control apparatus and a radio transmission/radio reception device, which are functionally connected and operated so the control apparatus controls at least parts of the functions of the radio transmission/radio reception device via the second interface, wherein the control is carried out in such a manner that the integration, in particular the machine process, is at least temporarily carried out at least using the communication, localization and/or sensing operation of the radio transmission/radio reception device.

14. The method as claimed in claim 13, wherein the control apparatus controls a multiplicity of first radio transmission/radio reception devices.

15. The method as claimed claim 13, wherein at least two first radio transmission/radio reception devices are controlled by the control apparatus in such a manner that they at least temporarily maintain a communication connection, in particular as part of a network, for example formed in the manner of the mesh, in which case they form a radar in the manner of the so-called “Multiple Input Multiple Output”, MIMO, array in this time.

16. The method as claimed in claim 13, wherein at least one of the multiplicity of first radio transmission/radio reception devices is controlled by the control apparatus to receive signals in such a manner that localization, in particular of its own position, is carried out on the basis of the received signals.

17. The method as claimed in claim 13, characterized in that at least one of the multiplicity of first radio transmission/radio reception apparatuses is controlled by the control apparatus in such a manner that, as a sensor, it at least temporarily captures at least one value of at least one physical variable.
